(19) United States
(12) Patent Application Publication
(10) Pub. No.: US 2003/0069954 A1
(43) Pub. Date: Apr. 10, 2003

(54) Subnet pooling

(75) Inventors: Donghai Ma, Acton, MA (US); Ajit Nair, Framingham, MA (US); Craig Boyle, Auburn, MA (US)

Correspondence Address: Fogg, Slifer & Polglaze, P.A., P.O. Box 581009, Minneapolis, MN, 55458-1009, US

(73) Assignee: ADC Telecommunications, Inc.

(21) Appl. No.: 09/971,827

(22) Filed: Oct. 5, 2001

(51) Int. Cl. G06F 15/173

(52) U.S. Cl. 709/223

(57) ABSTRACT

Subnet pooling by host group type and internet service provider allows filtering of subnet pool and efficient assignment of an incoming host request to an appropriate subnet within a group and ISP of the host request types.

The present invention relates generally to telecommunications, and more specifically to assignment to pooling of subnets within a telecommunications network.

### BACKGROUND

Subnets within internet service provider (ISP) networks are ranges of internet protocol (IP) addresses. The subnets are utilized to allow effective assignment of users within an ISP so that the ISP does not overload one subnet over another subnet. The users among ISPs are often assigned to level loads among the various subnets of the ISP.

A provisioning system, such as a provisioning server, is responsible for provisioning, or configuring, user access devices such as cable modems (CM), media termination adapters (MTA), and customer provided equipment (CPE). The provisioning system accomplishes this by generating configuration files from a configuration information database or the like, knowing the type of device that is requesting access and assigning an IP address from a subnet accordingly. A provisioning system typically includes a dynamic host configuration protocol (DHCP) server having a processor, memory, and some type of mass storage such as a hard drive or the like, and a trivial file transfer protocol (TFTP) server, a system log (SYSLOG) server, and a time-of-day server. The provisioning system may be a single computer functioning as all of the elements, or may be multiple computers connected together to function as a provisioning system.

Typically, ISPs within a provisioning system have multiple subnets assigned to them. These subnets are used to level or balance the load among the ISP so that it can provide good quality service with acceptable speeds and available bandwidth. The subnets are also used to monitor and track user usage and the like.

There is a need in the art for an improved pooling of subnets to allow further functionality.

### SUMMARY

In one embodiment, a method of pooling subnets within a network includes defining a number of subnets and a number of groups. Each subnet is then assigned to one of the groups according to a predetermined assignment scheme.

In another embodiment, a method of assigning a host to a subnet includes determining a type for the host, and assigning the host to a pool based on the determined host type. The host is then assigned within the pool to an appropriate subnet of a group of subnets.

In yet another embodiment, a method of pooling subnets in a network includes defining a number of subnets, some of the subnets having an association to an internet service provider, and each subnet having a subnet group type. At least one of the subnet groups is tagged, with each subnet identified as belonging to a specific internet service provider.

In still another embodiment, a method of operating a server includes identifying a host connecting to the server, identifying an ISP to which the host subscribes from a group of ISPs, and picking out subnets within the server that correspond to the identified ISP.

In still yet another embodiment, a communications network includes a user device network, a device termination system, and a provisioning system having a DHCP server, a TFTP server, a SYSLOG server, a time-of-day server, and a network connection to the device termination system. The DHCP server runs a computer program that performs a method on the DHCP server for subnet pooling and assignment of a connecting device to a subnet within the system.

Other embodiments are described and claimed.

### BRIEF DESCRIPTION OF THE DRAWINGS

FIG. 1 is a flow chart diagram of a method according to one embodiment of the present invention;

FIG. 2 is a flow chart diagram of a method according to another embodiment of the present invention;

FIG. 3 is a flow chart diagram of a method according to yet another embodiment of the present invention;

FIG. 4 is a block diagram of a subnet pool according to one embodiment of the present invention;

FIG. 5 is a block diagram of a server on which embodiments of the present invention are practiced; and

FIG. 6 is a block diagram of a network on which embodiments of the present invention are practiced.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

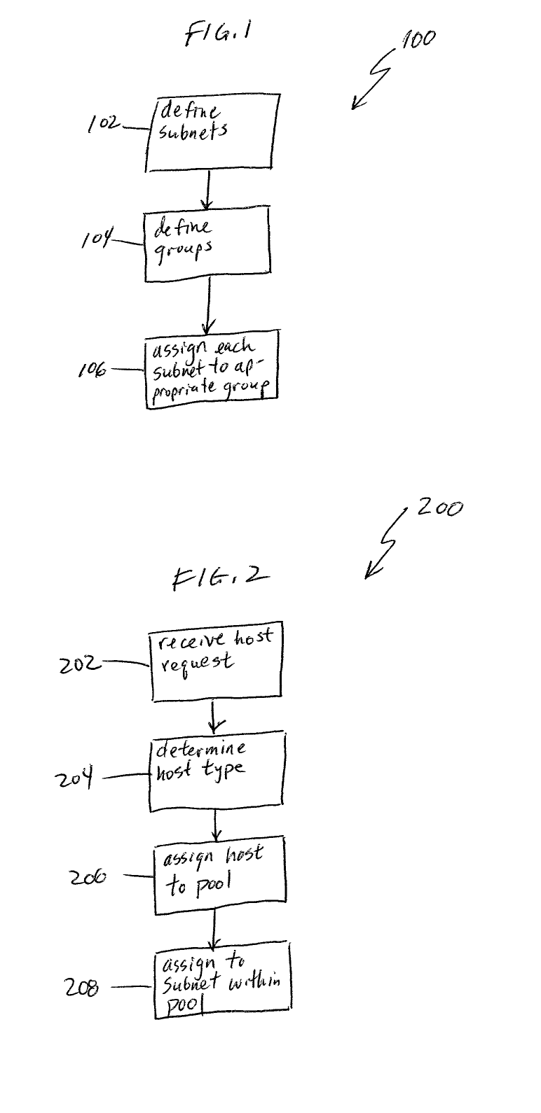

FIG. 1 is a flow chart diagram of a method 100 for assigning a host to a subnet according to one embodiment of the present invention. Method 100 comprises defining a plurality of subnets within a subnet pool in block 102, and defining a plurality of groups to which the subnets are assignable in block 104. Each subnet is assigned to an appropriate one of the plurality of groups in block 106. In one embodiment, each subnet contains a range of internet protocol (IP) addresses assigned to a particular internet service provider (ISP). Further, the groups are in one embodiment representative of categories or classes of devices that might connect to the network. In one embodiment, the groups include cable modems (CM), media transfer adapters (MTA), authenticated customer provided equipment (CPE), and unauthenticated CPE. Authenticated CPEs are those CPEs that are known to the system because they have registered with the system. Unauthenticated CPEs are unknown to the system. Configuration information for unauthenticated CPEs will need to be generated through discovery of the type of CPE and the like before the CPE can be authenticated.

As part of an open access system, the operator is allowed to define the subnets. Groups of subnets are arranged, so that all of the subnets belonging to one group are organized together. The operator can then tag each subnet with its specific ISP, allowing multiple subnets and multiple ISPs within a single group. This tagging of the subnets with particular ISPs allows the system to filter within a host request to pick out the host type, allowing easy assignment of an IP address to the access device requesting access.

In another embodiment, a method 200 for assigning a host requesting access to a network to a subnet is shown in FIG. 2. Method 200 comprises receiving a request for access to a network from a host such as a CM, MTA, CPE or the like in block 202, and determining the host type in block 204. Once the host type is determined, the host is assigned to a pool in block 206. The pool to which the host is assigned is determined by knowing the host type, and assigning the host to a pool that contains subnets that correspond to the type to which the host belongs. Once the host is assigned to a pool, the host is further assigned to a subnet within the pool in block 208. This assignment within the pool is in one embodiment further broken into assignment to a group within the pool according to host type, and to an ISP subnet within the group according to the ISP to which the host subscribes or to which the host is registered.

A method embodiment 300 for operating a server responsible for assignment of a host to a subnet is shown in FIG. 3. Method 300 comprises identifying a host attempting to connect to the server in block 302, and identifying an ISP to which the host is subscribed or registered in block 304. Once the ISP to which the host is subscribed or registered is determined, process flow continues with filtering the available subnets using the host type and ISP in block 306, and assigning the host to an appropriate subnet in block 308. The appropriate subnet to which the host is assigned is determined in one embodiment by filtering based on the determined host type or the determined ISP, or both.

For example, a request by a cable modem (CM) for assignment to a subnet within a network is received at a computer, system, or server purposed for that task. The type of the host, that is CM, is determined. Once it is determined that the host is a CM, the system or software running on the system filters available subnets by group, in this case the group being the group encompassing CMs. A further filtering is performed in one embodiment by ISP. The ISP of the CM is determined, and the filtering process filters to only those subnets that are within the CM group, but also only those available subnets assigned to the particular ISP to which the CM is registered. There may be one or more available subnets that meet all filtering criteria. In that case, an assignment scheme can be employed for assigning the host to a subnet. Such schemes are known in the art and will not be described further herein.

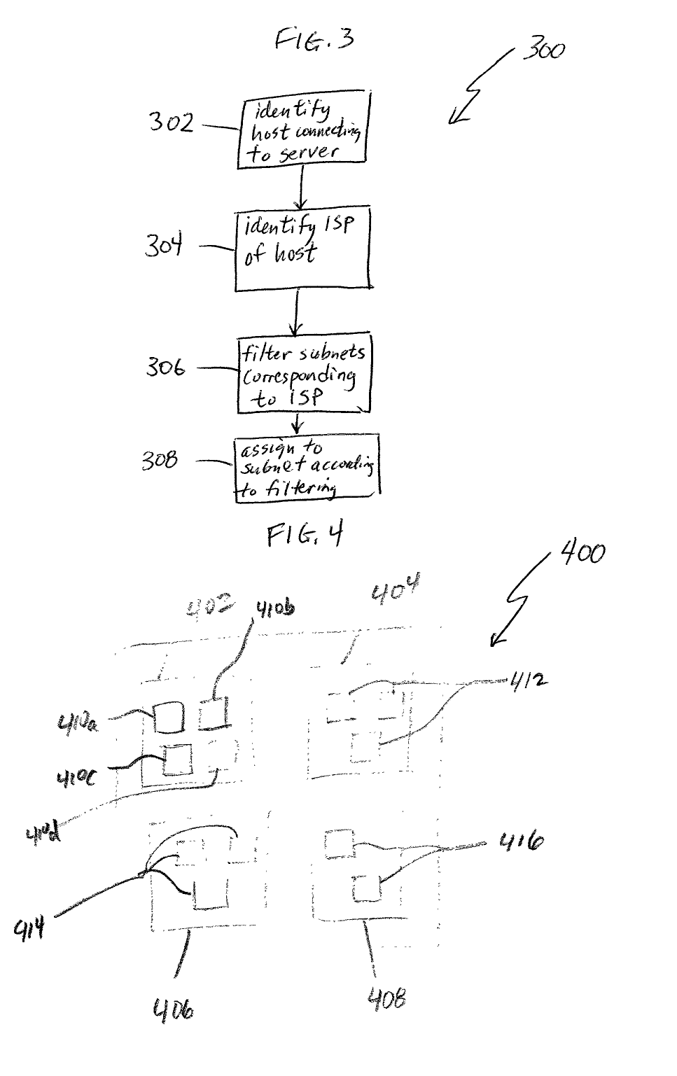

FIG. 4 is a block diagram of a subnet pool 400 according to another embodiment of the present invention. The subnet pool 400 comprises groups 402, 404, 406, and 408 of types of hosts. In one embodiment, the groups are cable modems, MTAs, authenticated CPEs, and unauthenticated CPEs, respectively. Within the groups 402, 404, 406, and 408 are individual subnets 410, 412, 414, and 416, respectively. The subnets are in one embodiment each assigned to their own ISP. For example, each of the subnets 410a, 410b, 410c, and 410d are assigned to an ISP. More than one subnet 410a . . . d may be assigned to the same ISP, but in this embodiment all addresses within a subnet are assigned to the same ISP.

In operation, the subnet pool and the methods work as follows. When a host wishes to connect to the network and be assigned to a subnet, the host type is determined. Then, based on which ISP the host is subscribed to, the available groups and subnets are filtered within the pool to pick out only subnets that correspond to the group type of the host as well as the ISP of the host. Once an appropriate subnet has been determined through the filtering process, an IP address is assigned to the host. In one embodiment, the IP address for the host also includes the capability of assigning IP addresses within the ISP and subnet to any and all CPEs connected to the host, such as a personal computer or the like connected behind a host cable modem. In one embodiment, a gateway internet address (GIADDR) is used to determine the ISP to which a host is subscribed.

In one embodiment, multiple pools are used. Each pool is also subdivided as discussed above. When a request from a host for access comes in to a provisioning server or other assignment computer, the host type is determined, and the pool is picked based on the GIADDR of the host. Once the pool and the host type are known, assignment within the pool is to the next host type subnet according to a predetermined assignment scheme.

In another embodiment, another level of access control is used. In an open access system, when a request comes in to the system, a pool for the request is picked. Once a pool is picked, a group within the pool is selected. Once the group within the pool is selected, an ISP within the group is selected. Each groups has a number of subnets within the group, with each subnet in this embodiment assigned to a particular ISP. In one embodiment, the assignment to a subnet is based on the ISP.

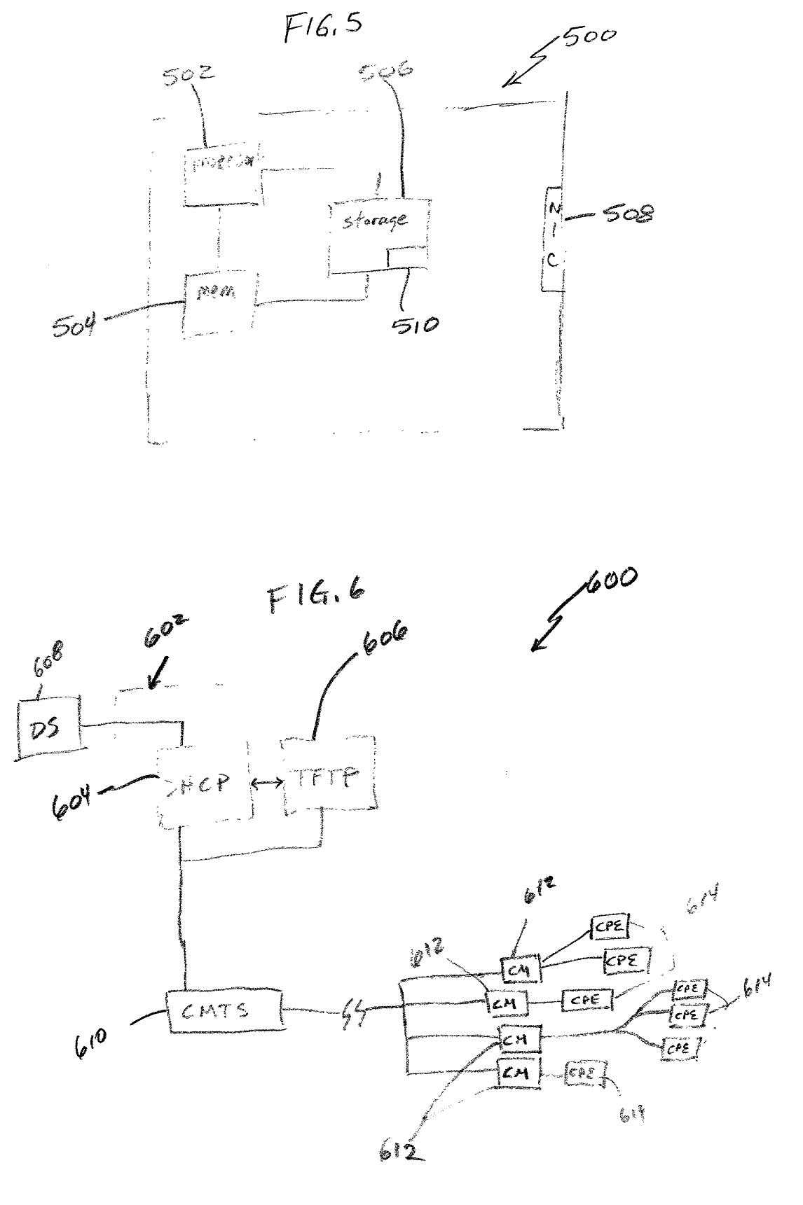

FIG. 5 is a block diagram of a computer 500 on which embodiments of the present invention are practiced. Computer 500 comprises a processor 502 connected to a memory 504 and mass storage 506. Mass storage includes by way of example only and not by way of limitation, hard drives, disk drives, optical drives, magnetic media drives, CD- and DVD-ROM drives, and the like. The computer 500 has a network connection 508 such as a network interface card (NIC) or the like. In one embodiment, a computer program 510 is stored in storage for operation in memory by the processor. The program is implemented to cause the computer 500 to perform a method such as those methods described above. In one embodiment, the computer is part of a provisioning server for a communications network.

FIG. 6 is a block diagram of one embodiment 600 of a network employing embodiments of the present invention. Network 600 comprises a provisioning system 602 which in turn comprises a dynamic host configuration protocol (DHCP) server 604, a trivial file transfer protocol (TFTP) server 606, SYSLOG and time-of-day servers (not shown), and a directory server 608, which in various embodiments is local or remote. The provisioning system is connected to a network termination device such as cable modem termination system 610, which is in turn connected to a number of user access devices such as cable modems 612. Each cable modem 612 has connected behind it in the network at least one CPE 614, and in some cases multiple CPEs 614. Operation of provisioning systems such as system 602 are known in the art and will not be described further herein.

The methods shown in FIGS. 1, 2, and 3 may be implemented in whole or in part in various embodiments in a machine readable medium comprising machine readable instructions for causing a computer such as is shown in FIG. 5 to perform the methods. The computer programs run on the central processing unit 502 out of main memory 504, and may be transferred to main memory from permanent storage 506 via disk drive or CD-ROM drive when stored on removable media or via a network connection 508 or modem connection when stored outside of the computer 500, or via other types of computer or machine readable media from which it can be read and utilized.

Such machine readable media may include software modules and computer programs. The computer programs may comprise multiple modules or objects to perform the methods in FIGS. 1, 2, and 3 or the functions of various apparatuses of FIGS. 4, 5, and 6. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### CONCLUSION

Operators of network access systems such as provisioning systems and the like want and need to keep track of leases or IP addresses that they assign to hosts such as cable modems, MTAs, CPEs, and the like. Structure in the assignment of such leases allows the operator to easily and quickly determine whether certain ISPs, subnets, or groups within a pool are capable of handling network activity, and where, if any, changes, additions, and modifications should be made to the system structure.

The subnet pool structure of the embodiments of the present invention provides such a capability by categorizing an incoming host request to a host type, as well as to an ISP if available. Once the host type and/or ISP are known, the embodiments of the present invention allow filtering of the various subnets to narrow the choices for subnet assignment to those that are germane to the request.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method of pooling subnets within a network, comprising:
defining a plurality of subnets;
defining a plurality of groups; and
assigning each subnet to one of the plurality of groups.

2. The method of claim 1, wherein defining a plurality of groups comprises defining groups of cable modems, media termination adapters, authenticated customer provided equipment, and unauthenticated customer provided equipment.

3. The method of claim 1, and further comprising:
assigning each subnet to one of a plurality of internet service providers.

4. The method of claim 1, and further comprising:
tagging at least one of the groups for a specific internet service provider.

5. A method of assigning a host to a subnet, comprising:
determining a type for the host;
assigning the host to a pool based on the determined host type; and
assigning the host within a pool to an appropriate subnet.

6. The method of claim 5, and further comprising:
determining a pool for the host.

7. The method of claim 6, wherein determining a pool comprises:
determining a gateway internet address for the host; and
matching the gateway internet address to a pool containing the address.

8. The method of claim 5, wherein assigning the host within the pool comprises:
filtering the pool to remove all non-type subnets; and
assigning the host within one of the remaining subnets.

9. The method of claim 5, and further comprising:
assigning each subnet to one of a plurality of internet service providers.

10. A method of pooling subnets in a network, comprising:
defining a plurality of subnets, each subnet belonging to one of a plurality of host type groups;
tagging at least one of the plurality of subnets for specific internet service providers; and
assigning a host attempting to connect to the network to a subnet according to its group type and internet service provider.

11. The method of claim 10, wherein assigning a host further comprises;
identifying a host type for the host;
identifying an internet service provider for the host; and
filtering the subnets to remove all non-type and all non-internet service provider subnets.

12. The method of claim 10, wherein assigning a host further comprises:
assigning the host within one of a group of type specific and internet service provider specific subnets.

13. A machine readable medium having machine readable instructions for causing a computer to perform a method, the method comprising:
defining a plurality of subnets;
defining a plurality of groups; and
assigning each subnet to one of the plurality of groups.

14. A method of operating a DHCP server, comprising:
identifying a host connecting to the DHCP server;
identifying an ISP to which the host subscribes from a group of ISPs; and
picking out a subset of a plurality of subnets within the DHCP server that correspond to the identified ISP.

15. The method of claim 14, and further comprising:
filtering the plurality of subnets to pick out a subnet for the host that is specific to the group and ISP of the host.

16. A subnet pool, comprising:
a plurality of groups; and
a plurality of subnets, each of the subnets assigned to one of the plurality of groups.

17. The subnet pool of claim 16, wherein the groups include cable modems, media termination adapters, authenticated customer provided equipment, and unauthenticated customer provided equipment.

18. The subnet pool of claim 16, wherein each of the subnets is further assigned to one of a plurality of internet service providers.

19. A subnet pool, comprising:
a plurality of subnets commonly assigned into a pool;
wherein each of the subnets is a member of a group of subnets, wherein the group of subnets includes groups of cable modems, groups of MTAs, groups of authenticated CPEs, and groups of unauthenticated CPEs.

20. A network comprising:
a user device network;
a device termination system; and
a provisioning system having a DHCP server, a TFTP server, a SYSLOG server, a time-of-day server, and a network connection to the device termination system, the DHCP server having a computer readable medium stored thereon, the computer readable medium for causing the DHCP server to execute a method of subnet pooling, the method comprising:
identifying a host connecting to the DHCP server;
identifying an ISP to which the host subscribes from a group of ISPs; and
picking out subnets within the DHCP server that correspond to the identified ISP.
